(19) United States
(12) Patent Application Publication
(10) Pub. No.: US 2011/0275047 A1
(43) Pub. Date: Nov. 10, 2011

(54) Seeking Answers to Questions

(75) Inventors: Benedict A. Gomes, Mountain View, CA (US); Corin Anderson, Mountain View, CA (US); Shashi Seth, Foster City, CA (US); Rami Bitar, San Francisco, CA (US); Udi Manber, Los Altos Hills, CA (US)

(73) Assignee: GOOGLE INC., Mountain View, CA (US)

(21) Appl. No.: 13/188,422

(22) Filed: Jul. 21, 2011

Related U.S. Application Data
(63) Continuation of application No. 11/690,038, filed on Mar. 22, 2007.
(60) Provisional application No. 60/882,788, filed on Dec. 29, 2006.

(51) Int. Cl. G09B 7/00

(52) U.S. Cl. 434/350

(57) ABSTRACT

A computer-implemented method of seeking answers to questions comprises receiving one or more questions from users seeking answers, maintaining an inventory of pending questions to be answered, and transmitting a question from the pending question inventory to a network location determined to be topically relevant to the transmitted question based on the content of the network location.

### CROSS REFERENCE TO RELATED APPLICATIONS

This application is a continuation application of, and claims priority to, pending U.S. patent application Ser. No. 11/690,038, filed on Mar. 22, 2007, entitled “Seeking Answers to Questions”, which claims priority under 35 U.S.C. §119(e) to U.S. Provisional Application Ser. No. 60/882,788, filed on Dec. 29, 2006, and entitled “Seeking Answers to Questions”. The entire disclosures of both of the prior applications are hereby incorporated by reference.

### TECHNICAL FIELD

The following description relates to systems and techniques for seeking answers to questions, for example, by strategically presenting certain questions at locations on a computer network.

### BACKGROUND

As the Internet has become increasingly popular, computer networks are becoming an important and pervasive mechanism for communication, entertainment, and professional and social networking In addition, networks connect users with knowledge and information on a variety of subjects to other users seeking knowledge and information on those subjects. Networks also present a medium by which users can exchange ideas by asking and answering questions on matters of common interest.

Currently, users with questions log on to a web site where they can present questions. The questions are displayed on the web site and are viewed by other users also logged on to the web site. One or more users present an answer to the question. The answers are then displayed to the user who presented the question.

### SUMMARY

The present inventors recognized a communication gap between users with questions and knowledgeable users since the former may not know where to find the latter. Also, a user presenting a question may not be assured that the source of an answer is the most knowledgeable. Further, if questions are presented at a centralized location in a network, an expert may be unaware that a question related to their field of expertise has been presented unless the expert visits the centralized location and searches for questions related to their field. This additional effort may deter the expert from seeking questions and providing answers.

In general, this document describes systems and techniques for seeking answers to questions by placing the questions in locations within a network where a presumably knowledgeable user may view the question and provide an answer to the question. In one example, a system receives a request from a network location, for example, a web site, to display a question and presents a question deemed to be relevant to the web site on a web page of the web site. The web site is likely to be visited by experts or others likely to be able to answer the presented question.

In one aspect, a computer-implemented method of seeking answers to questions is described. The method includes receiving a question from a user seeking one or more answers, wherein the user presents the question at a first network location, maintaining a question inventory of pending questions to be answered, and presenting to a second network location a question from the question inventory determined to be topically relevant to the second network location based on content of the second network location. Other implementations of this aspect can include corresponding systems.

These and other aspects can include one or more of the following features. The first and second network locations can be different from each other. The question can be received via a medium including one or more of a form on a web page, a personal digital assistant (PDA), an electronic mail (e-mail), a cellular telephone, an audio file, and a video file. The network locations can include one or more of a web page of a web site, an internet protocol television, and a display screen on a cellular telephone. The question can be presented to the second network location in response to a request from the second network location. Presenting the question can include receiving the request from the second network location, selecting the question from the question inventory if the question is relevant to a content of the second network location, and transmitting the question to the second network location. Transmitting the question can include transmitting the question to an entity controlling the second network location, and displaying the question to a user along with the second network location contents. Transmitting the question can further include displaying a functionality on the second network location to facilitate entry of an answer to the question. The functionality can include one or more of a text box to enter the answer, an option to upload a file including the answer, and a hyperlink to the second network location to enter the answer. Selecting the question can include comparing the questions in the question inventory with the second network location contents. The question inventory can include words or word clusters derived from the question, and a map linking the question with the words or word clusters appearing in the question. The comparing can include identifying words or word clusters in the second network location, and finding, in the question inventory, words or word clusters in a question that match the words or word clusters in the second network location. The method can further include receiving an answer to the question from the second network location, generating a response to the question, the response including one or more of the answers received, attributes of the network location wherefrom the answer was received, and a rating for the question from the network locations, and maintaining an answer inventory, wherein the answer inventory includes the response to the question and a map linking the response to the question to the corresponding question. The method can further include filtering the one or more answers for improper content, wherein the improper content can include one or more of content not relevant to the question, obscenities, and meaningless content. The method can further include transmitting the response to the question to the user that posed the question. The method can further include transmitting the response to the question to the first network location. The transmitting can include sending the response to an entity controlling the first network location, and displaying the response at the first network location. The method can further include receiving a rating for the response to the question from a user.

In one aspect, a computer-implemented method of presenting questions to topically relevant web pages on the internet is described. The method includes receiving a new question from a first server hosting a first web site, adding the new question to a question inventory, receiving a request for content from a second server hosting a second web site, identifying new questions in the question inventory that are relevant to the content of web pages of the second web site, transmitting the identified one or more new questions to the server hosting the second web site, and displaying the identified one or more new questions on a web page of the second web site.

In one aspect, a system for presenting questions to topically relevant web pages on the internet is described. The system includes means for receiving a new question from a first server hosting a first web site, means for adding the new questions to a question inventory, means for receiving a request for content from a second server hosting a second web site, means for identifying one or more new questions in the question inventory that are relevant to content of web pages of the second web site, means for transmitting the identified one or more new questions to the server hosting the second web site, and means for displaying the identified one or more new questions on a web page of the second web site.

The system and techniques described here may provide one or more of the following advantages. A system can provide network users who have questions, a mechanism to obtain answers to the questions. The system can provide users who are experts on topics, a forum to share their expertise. In doing so, the system can bridge the communication gap between users with questions and users with expertise. Presenting questions at topically relevant locations increases the likelihood that questions are viewed and answered by knowledgeable users. Since the knowledgeable users do not need to seek questions, the probability that questions will be answered increases since the effort required to seek the questions are significantly reduced. Consequently, a user presenting the question is assured that their questions are not only answered but also that the answers are obtained from knowledgeable sources.

Additionally, the system can create an extensive database containing information on a variety of topics obtained from such question and answer exchange. In this manner, the content of the network can be enriched. Also, a system can provide entities hosting network locations, such as servers hosting web sites, incentives to enhance the content of their web sites and improve their topical relevance so that more questions can be displayed. This, in turn, may increase network traffic through the web sites, which, in turn, may provide advertisers incentives to place advertisements at those sites. In this manner, the entities hosting network locations may be able to obtain financial benefit for hosting locations containing high quality content.

The details of one or more implementations are set forth in the accompanying drawings and the description below. Other features and advantages will be apparent from the description and drawings, and from the claims.

### DESCRIPTION OF DRAWINGS

FIG. 1 is a block diagram of an example of a system for seeking answers to questions.

FIG. 2 is a block diagram of an example of a server to connect users asking questions to users answering questions.

FIG. 3 is a flow chart of an example of a process of seeking answers to questions.

FIG. 4 is a flow chart of another example of a process of seeking answers to questions.

Like reference symbols in the various drawings indicate like elements.

### DETAILED DESCRIPTION

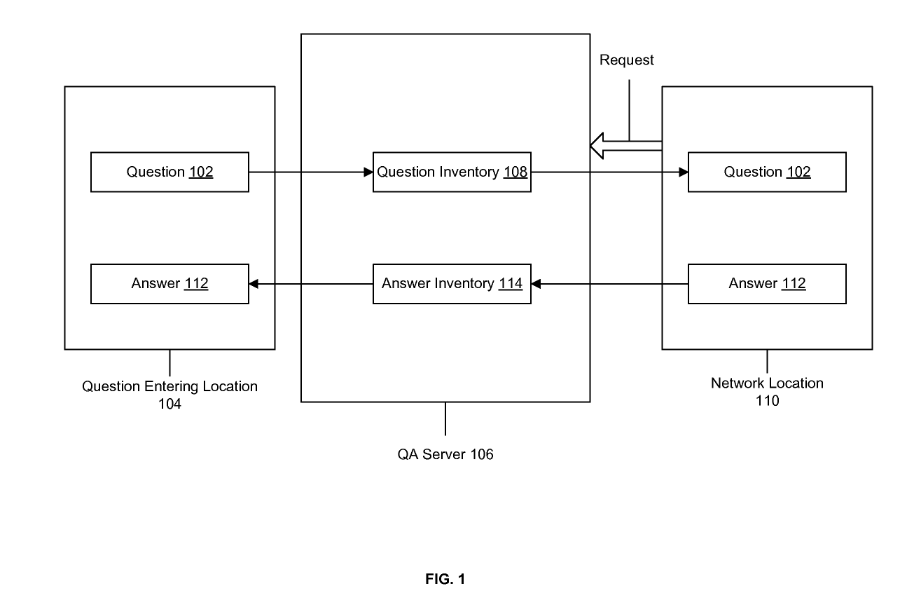

FIG. 1 depicts an example of a system for seeking answers to user-submitted questions in a network. The network comprises interconnected locations containing content. In one implementation, the network is the internet and the network locations include some or all web pages of web sites available on the internet. Other examples of networks include local area networks (LAN), wide area networks (WAN), cellular telephone networks, and intranets.

A user inputs a question 102 at a question entering location 104 accessible via the network. In one implementation, the question entering location 104 is a web page of a web site on the internet and can be accessed using a web browser application that is pointed to a specific URL (uniform resource locator) to view the question entering web page. In one aspect, the question entering location is a browser toolbar. Virtually any suitable input device and/or user interface (e.g., desktop computer, notebook computer, smart phone, Personal Digital Assistant (PDA)), wired or wireless, can be used to access the question entering location 104 and to input the question for which answers will be sought. Alternatively, or in addition, the question entering location 104 can be implemented using a user interface mechanism other than a web browser, for example, an email message, an instant message, an SMS or text message, orally via language recognition software, and/or special purpose client software executing on the input device.

In one implementation, the user enters the question 102 as text in a text box in a web browser application. The text includes rich text such as HTML. Alternatively or in addition, the question may be in the form of an audio file, video file, or a combination of multiple formats. For example, the user may record the question 102 orally via speech recognition software and save the question as an audio file. The user may then upload the audio file using an interface mechanism into the question entering location 104. In another aspect, the question 102 may be a combination of formats, such as an audio file of a song including text that reads, “Who is the artist?”.

As shown in FIG. 1, the QA (Question-Answer) server 106 receives a question 102, processes the question 102 and stores it in a question inventory 108. The processing includes identifying the individual words in a question, grouping one or more words to form one or more word clusters, and may include ignoring commonly occurring words. The question inventory 108 includes new and old questions. The old questions include questions that have been answered and questions that are yet to be answered. The question inventory 108 includes a map linking a question to the words or word clusters derived from the question. The question inventory 108 may reside on an external storage unit with capabilities to communicate with the QA server 106.

The QA server 106 receives a request from a network location 110 to display a question. The network location 110 may be a web site in the network. The network location 110 may contain content including text, images, and video. The contents of the network location 110 are compared against the questions in the question inventory 108 to determine a question that may be answered by an expert if posted on the network location 110. In this manner, the network location 110 is determined to be topically relevant to a question 102 stored in the question inventory 108.

In one aspect, the network location 110 is a web site. The server hosting the web site may send a request to the QA server 106 for a question 102. The QA server 106 may identify a question 102 from the question inventory 108. The QA server 106 may request permission from the server hosting the web site to post the question on one or more pages of the web site. The QA server 106 may receive such requests from one or more servers hosting web sites based on factors including prior arrangements between the QA server 106 and the servers hosting the web sites and the web site publisher's desire to display questions on the web site to increase traffic and user interactions. The server hosting a web site may include a list of acceptable sources of questions, acceptable users, and acceptable questions. The sources may include web sites in the network. A server hosting a web site may explicitly express the topics for which questions will be displayed on the web site. The topics may include a list of topics, a list of key words, a list of sources of questions, or combinations thereof. The QA server 106 may choose a question 102 from the question inventory 108 that satisfies one or more of the above and additional criteria.

The QA server 106 includes a map linking questions 102 to words or word clusters derived from questions in the question inventory 110. When the QA server 106 receives a request for a question 102 from a network location 110, the QA server 106 compares words or word clusters derived from the network location 110 with some or all the words or word clusters derived from the pending questions in the question inventory 108. The QA server 106 uses the one or more words or word clusters in the pending questions in the question inventory 108 to determine topically relevant questions 102 that can be displayed at the network location 110 from which the request was received.

The QA server 106 receives a request from one or more servers hosting web sites to present questions at the web site. In one aspect, the request for a question is sent exclusively to the QA server 106. In another aspect, the QA server 106 is notified when a request is sent to a different server. For example, when a request for advertisements is received by an ad server, such as the AdSense server, the ad server may notify the QA server 106 of the request and the web site from which the request was received.

In one implementation, the system including the QA server is exclusively an answer seeking system. In another implementation, the QA server is a part of a system that provides questions and advertisements to web sites. The system may present the question along with or in place of advertisements requested for display by the web site. In another aspect, the system may receive a request for both questions and advertisements to be sent to the web site.

The QA server 106 transmits the identified topically relevant question to the server hosting the web site from which the request was received, for display at a web page on the web site. The QA server 106 may receive requests from one or more such servers, determine that the same question is topically relevant to the web sites, and transmit the question to some or all the servers. In one aspect, the QA server 106 may require that the server hosting the web site display the question on a specific web page of the web site, for example, the home page, to maximize viewing of the question by users who visit the web site. In another aspect, the QA server 106 may transmit the question to the server hosting the topically relevant web site. The server hosting the web site may decide the web page where the question is displayed. In another implementation, the QA server 106 may transmit the response to the browser of the user who presented the question.

A user viewing the web page enters an answer 112 upon seeing that a question 102 is displayed. In one implementation, the user views a question that is in text format and enters an answer in a text box provided. Alternatively, or in addition, the user may also enter the answer in other formats including audio files, video files, and combinations of multiple formats. The answer presented by the user may be in a format other than that of the question. For example, if the question is an audio file of a song, the answer identifying the artist who performed the song may be in text format.

In one aspect, the text box to enter an answer to the question is displayed on the same web page as the question so the user can enter an answer without leaving the web page. In another aspect, a functionality to facilitate entry of an answer may be located at a second web page, either on the same web site or on a different web site. For example, a question may be displayed on a home page of a web site. A text box for entering an answer may be on a second web page of the web site. The home page and the second page may be linked through a hyperlink, such that the hyperlink on the home page points to the web page with the text box to enter an answer. In another aspect, the answer entering location may be a toolbar extension or an HTML interface generated using AJAX that is embedded on the web page but is normally hidden from view.

The QA server 106 receives the answer 112 from the server hosting the topically relevant web site and stores the answer in an answer inventory 114. In one aspect, the QA server 106 may receive more than one answer 112 from the web site. The QA server 106 may impose no limit on the number of answers received from the same web site every time a question is displayed. The QA server 106 may restrict the number of times a question 102 is displayed at the same location 110. In another aspect, the QA server 106 may receive one or more answers 112 from some or all the web sites where the question was presented. The QA server 106 may limit the number of answers received based on factors that may include the total number of responses to a question, the satisfaction rating of the user who presented the question, the number of similar questions in the question inventory 108, and the number of answers available to the similar questions in the answer inventory 114.

The QA server 106 transmits the answer 112 to the server hosting the web site where the question was presented 104. In one aspect, the QA server 106 may choose a web page on the web site to display the answer. In another aspect, the QA server 106 may transmit the answer to the server hosting the web site. The server may choose the location to display the answer.

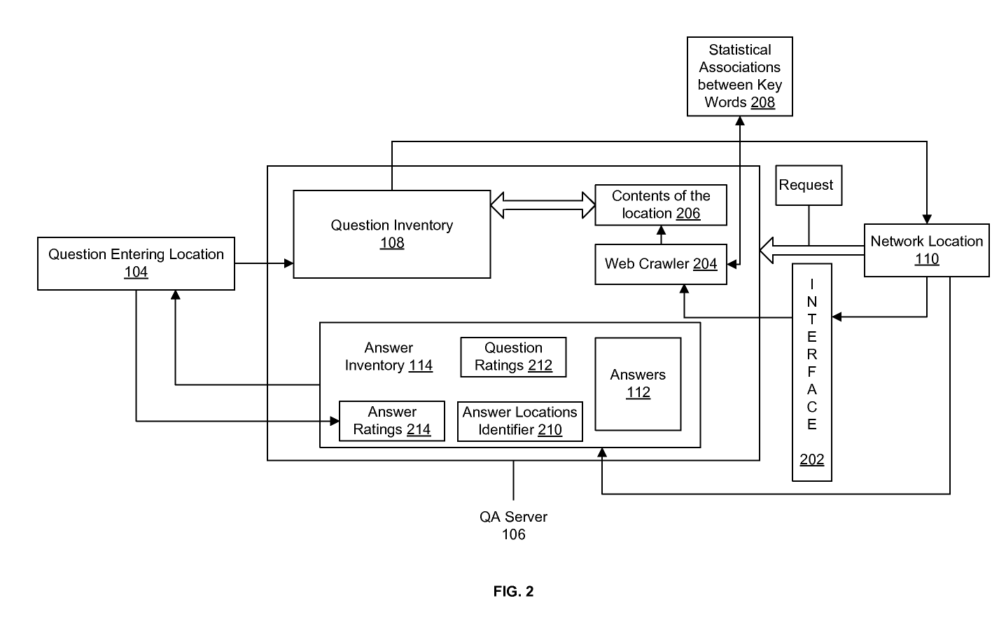

FIG. 2 depicts a block diagram of an example of a server to connect users asking questions to users answering questions. The QA server 106 includes a question inventory 108 that stores the questions received from a question entering location 104. The questions stored in the question inventory 108 include new questions, old questions that are pending answers, and old questions that have been answered. Additionally, the question inventory 108 includes a map linking a question to words or word clusters derived from the question.

The QA server 106 receives a request from a network location 110 for a question. In one implementation, the network location is a web site on the internet. The QA server 106 receives the contents of the web pages of web sites on the internet through an interface 202. A web crawler 204 traverses the web pages of the web site and determines the topic of the web site. In addition, the web crawler 204 can generate statistical associations between key words and the content on the web pages. For example, the web page can contain information used by the web crawler to identify what key word may be related to the content on the web page. This information can include text within the web page, key words (e.g., metadata) that describe the content, frequencies of words occurring on the web page, font size of text on the web page, or a hyperlink structure within the web page. The web crawler 202 can store the statistical associations in a repository 208.

The QA server 106 receives a request from a network location 110 to display questions. The QA server 106 crawls the network location 110 to determine the topic of the location. Subsequently, the QA server 106 compares the topic of the network location with the questions in the question inventory 108 to identify questions that are relevant to the network location. In comparing the questions with the topic of the network location, in one implementation, the QA server 106 may separate the question into individual words, identifies and ignores commonly occurring words (e.g., articles, “what”, “where”, etc.), and may group the remaining words into one or more clusters. In another implementation, the QA server 106 may consider all words in the question. The QA server 106 compares the topic of the network location with the words and word clusters derived from the questions in the question inventory 108. The QA server 106 finds either words or word clusters or both in the question inventory 108 that match the topic of the network location. For example, the QA server may receive a request from www.physics.com. The question inventory may contain a question that reads, “What is string theory?” In one aspect, the words “what” and “is” are ignored as common words, and the words “string”, and “theory”, and the word cluster “string theory” are derived from the question. In another aspect, the words “string” and “theory” may further be filtered leaving only “string theory” as the derived word cluster for the question. The QA server crawls the contents of www.physics.com and determines that the topic of the web site is “physics”. Based on statistical associations, the QA server may associate “string theory” to “physics” and identify “what is string theory” as a question that is topically relevant to the network location www.physics.com.

The QA server 106 identifies one or more questions relevant to the topically relevant web site from which a request is received based on the map linking words and word clusters to corresponding questions, also stored in the question inventory 108. In addition, the QA server 106 may use additional words and word clusters to identify relevant questions. For example, if “bicycling” is identified as a word in a question, the QA server 106 may include the word “cycling” when comparing words and words clusters in the question inventory with words and word clusters in the network location. In addition to questions that contain the word “bicycling”, the QA server 106 may identify questions that contain the word “cycling” as questions that can be presented to the topically relevant web site from which the request was received.

The QA server 106 transmits a question to one or more servers hosting web sites in response to requests from the servers. In one aspect, the QA server 106 chooses one or more web pages from the web site to display the question. In another aspect, the QA server 106 transmits the question to the server hosting the web site which decides the one or more web pages to display the question.

A user viewing the web page sees the questions and enters an answer to the question. In one aspect, one question is answered by several users. In another aspect, one user enters several answers to the same question. The server hosting the web site transmits all the answers to the QA server 106. The QA server 106 may limit the number of answers to be transmitted to the web site wherefrom the question was received. Alternatively, the server hosting the web site may limit the number of answers to a question by removing the question from display upon receiving one or more answers.

The QA server 106 receives the answers 112 from the server hosting the web site where the question was presented and stores the answers in the answer inventory 114. In addition, the QA server 106 also stores information related to the web site in the answer entering location identifier 210. In one implementation, the QA server 106 generates a response to a question comprising the one or more answers 112 from users at the web site where the question was displayed, attributes of the one or more topically relevant network locations wherefrom the answers were received, and a rating for the question 212 from the one or more users in the one or more topically relevant network locations. In one aspect, the web page is identified by the URL that points to the web page. The QA server 106 receives and stores the ratings 212 in the answer inventory 114. The ratings may be based on relevance of the topic of the question to the content of the web site. The ratings may also be based on the quality of the question. A user presenting an answer may rank both the question and the user asking the question. The question ratings are used in future determinations of topically relevant questions in the question inventory with respect to locations requesting question.

The QA server 106 transmits the one or more responses to a question to the server hosting the web site from where the question was received. The one or more responses are displayed on a web page of the web site. In one aspect, the user who presented the question reads and rates the one or more responses. In another aspect, any user who reads the one or more responses can rate the responses. The answer ratings 214 are stored in the QA server 106 and used in future determinations of topically relevant questions with respect to locations requesting questions. In addition, the QA server 106 links the answers stored in the answer inventory 114 to corresponding questions in the question inventory 108 so that if the same or a similar question is presented to the QA server 106 by future users, the QA server 106 can retrieve the answer from the answer inventory 114 and present it to the user. In such instances, the user need not wait for the question to be presented to a topically relevant network location, and the time between presenting a question and receiving an answer is significantly reduced.

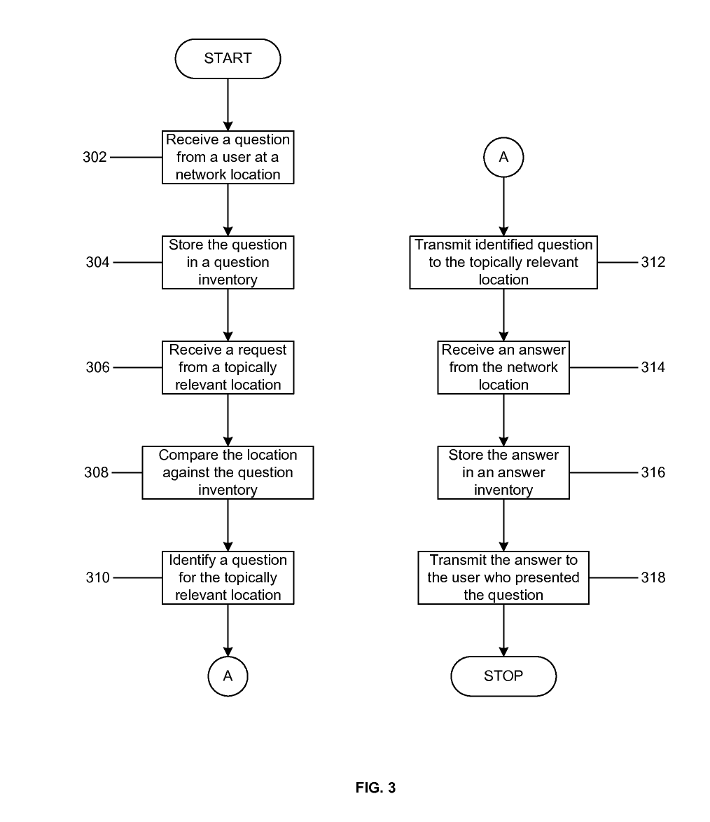

FIG. 3 depicts a flow chart of an example of a process of seeking answers to questions. In one implementation, the question is entered into a first web page of a first web site and is displayed on a second web page of a second web site. An answer is entered on the second web page of the second web site and displayed on the first web page of the first web site. The question is received by the QA server 106 from the server hosting the first web site at 302. The question is stored in the question inventory at 304. The stored questions include questions that have already been answered and questions that are pending.

A server hosting a web site requests a question from the QA server 106 at 306. More than one server may request the same question. The contents of the web site are compared with the questions in the question inventory at 308. One or more key words or word clusters derived from the contents of the web site are compared with key words or word clusters in the question inventory 108 to identify a question that is relevant to the web site requesting the question at 310. In one aspect, one or more of the words and the word clusters may be used to identify a question that is relevant to the web site requesting the question.

The identified question is transmitted to the server hosting the web site from which the request was received at 312. In addition, the question may be transmitted to multiple servers, each server having content relevant to the identified question. In addition, multiple relevant questions from one or more users may be transmitted to the same server hosting a topically relevant web site.

When a user views the contents of the web page, the user also sees the question displayed. One or more users input an answer to a question at the web site where the question is presented. In one aspect, the web page where the question is displayed includes a text box for the user to enter an answer in text format. In addition, the user may also rate the question. The rating may depend on factors including the relevance of the question to the web site, the subject of the question, the number of times that a similar question has been presented to the web site, and the number of times the same user has asked a question.

The QA server 106 receives the answer from the topically relevant web site at 314. In one aspect, only one answer may be received from the web site. In another aspect, an answer may be received from one or more users who viewed the question. In one aspect, the answer may be in the same format as the question. In another aspect, the answer may be in a format different from that of the question. The QA server 106 also receives attributes of the topically relevant web site such as IP address and URL. Additionally, the QA server 106 receives ratings for the questions displayed. The ratings may be provided by the users who viewed and answered the question.

The received answers are stored in an answer inventory 114 at 316. In one implementation, the answer is transmitted from the user's web browser to the QA server 106. In another implementation, the answer is transmitted to the QA server 106 by the server hosting the web site where the answer was entered. In addition, the attributes of the answer entering location 112 as well as ratings for the questions may also be stored in the answer inventory 116.

The answer is transmitted to the server hosting the web site where a user presented the question by the QA server 106 at 318. In addition, the information related to the web site from where the answer was received is also transmitted to the user. The user may rate the one or more answers and the one or more web sites from which the one or more answers were received. These ratings may be used by the QA server 106 in future determinations of questions relevant to the network location. In one aspect, the answer, information related to the web site, and the ratings may be grouped to generate a response.

Although a few implementations have been described in detail above, other modifications are possible. For example, the network in the system in FIG. 1 may be a cellular telephone network. The question and answer entering locations may be cellular telephones operated by users, such that the telephones are connected to one another through the cellular telephone network. A user may transmit a question to the network by entering a text message into the phone and transmitting the text message to the network. In addition, the user may transmit the question by placing a call to a contact number known to connect questions with answers. Depending on the capabilities of the cellular phone, the user may also transmit questions in alternate forms such as video. If the question is present in the question inventory of the cellular telephone network, an answer may be retrieved and transmitted to the user who placed the question. Alternatively, the question may be pending an answer. The users of the network may request to answer a pending question by placing a call to contact the number that contains the question inventory. The users of the network may be offered compensation and/or rewards as incentive to answer questions. One or more answers may be transmitted by users to the cellular telephone network. The one or more answers, along with the contact information of users who provided the answers may be transmitted to the user.

In another implementation, the QA server 106 may receive a request from an online social network to display questions. For example, an online community of rock climbing enthusiasts may wish to answer questions related to rock climbing by novices. The QA server 106 may identify a web page in the online social network that members of the community frequently visit and post the question on that page. In one aspect, the members of the community view the question while visiting the page. In another aspect, the server hosting the online social network may send a communication, such as electronic mail, to all its members with the question. The members of the network may visit the web page where the question is presented and enter an answer to the question. Alternatively, the members may reply to the communication received and include their reply in the communication. The server hosting the network may send some or all the responses to the QA server 106.

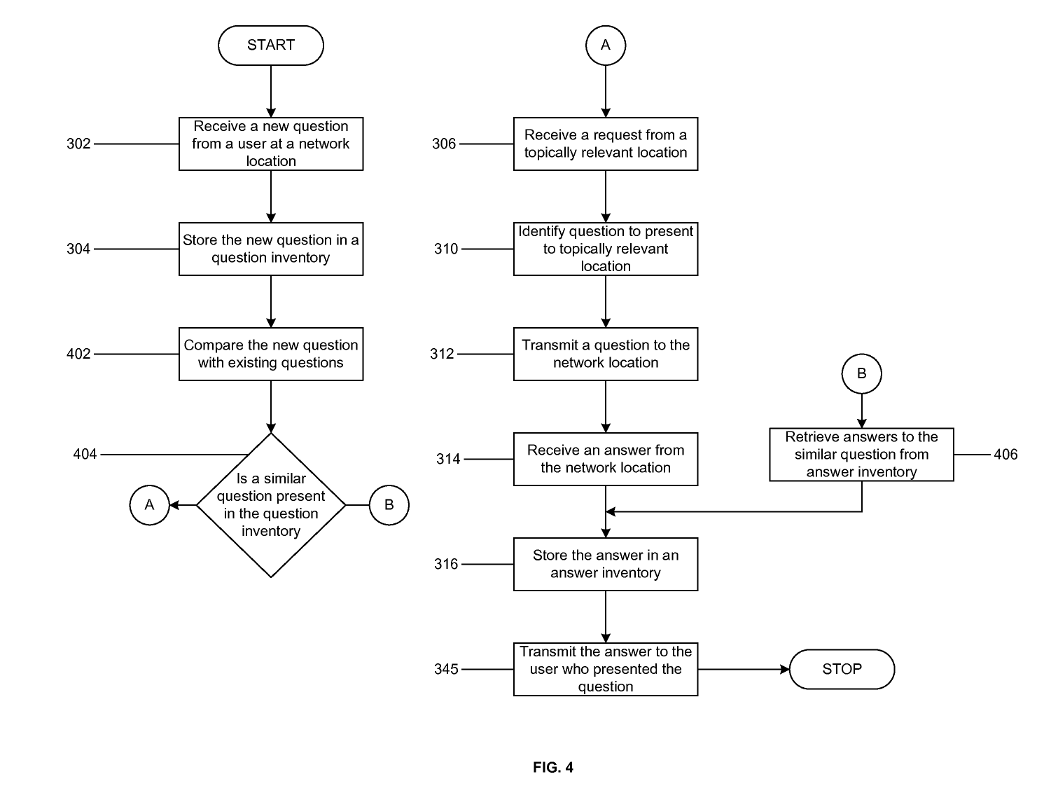

In another implementation, the QA server 106 may store the key words and word clusters derived for each question received by the QA server 106. The QA server 106 may create a map that maps the key words and word clusters derived for each question to the question stored in the question inventory 108. When a new question is received, the QA server may compare the new question to existing questions in the question inventory 108 at 402 to determine if the same or a similar question exists in the question inventory 108 as shown in FIG. 4 (404). Key words and word clusters derived for the new question may be compared with the key words of stored questions to determine same or similar questions in the question inventory 108. If either matching key words, matching word clusters or both are found for stored questions in the question inventory 108, the new question is treated as a stored question. In the absence of one or more questions with the same or similar key words or word clusters, the question is designated as a new question. In another aspect, the QA server 106 may process each question as a new question, regardless of the stored questions in the question inventory 108.

In one aspect, the QA server 106 may identify all stored questions with either key words, word clusters, or both, matching those of new questions and designate one or more of the stored questions to be similar to the new question. In another aspect, the QA server 106 may present the similar questions to the user and request user input to further identify same or similar stored questions. The user may choose one or more similar questions from the choices presented.

If a stored question is designated to be similar to a new question, the QA server 106 may retrieve the saved answer from the answer inventory 116 at 406 and present the answer to the user. In addition, the QA server 106 may also present the one or more web sites from which the stored answer was received. In this manner, the time taken for a user to receive one or more answers to a question is significantly reduced since an existing answer is retrieved from the answer inventory 116.

In another implementation, if a question is designated as similar to a new question, but an answer to the stored question has not been received from any of the web sites where the question was presented, the QA server 106 may present the web sites where the stored question is presented to the user presenting the new question. Thus, the user is informed that the question presented has been displayed on one or more topically relevant network locations.

In yet another implementation, the QA server 106 may disregard the new question and not store the new question in the question inventory 108. In another aspect, the QA server 106 may use the time elapsed from when the stored question was first answered to the time when the new question was presented to determine whether or not the new question should be re-presented to topically relevant network locations to obtain new and updated answers.

In another implementation, the answer received may be filtered by the QA server for improper content, such as an answer not relevant to the question, inappropriate content, for example, obscenities, and meaningless content, for example, gibberish.

In another implementation, when an answer is transmitted to a user, advertisements relevant to the question may also be included with the answer for display on the user's network location.

In another implementation, the QA server 106 may include a network inventory that stores the content of a plurality of web sites on the internet. Questions in the question inventory 108 may be compared with web sites in the network inventory to associate questions to topically relevant web sites. When a request is received from a web site, the question in the question inventory associated to the web site in the network inventory may be transmitted to the server hosting the web site from which the question was received. The contents of the network inventory may be periodically updated so that the content stored in the network inventory is most recent.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method of receiving answers to questions, the method comprising:
presenting to a first network location a question determined to be topically relevant to the first network location based on content of the first network location, wherein the first network location is a webpage in an online social network;
receiving an answer to the question from the first network location;
transmitting a response for display to a user at a second network location, wherein the response includes the answer to the question; and
receiving information relating to a rating for the answer from the user.

2. The method of claim 1, further comprising:
storing the rating for use in identifying one or more network locations that are topically relevant to the question.

3. The method of claim 1, wherein the rating is submitted by a first user that is different from a second user that submitted the question and that is different from a third user that submitted the answer.

4. The method of claim 1, wherein the question is presented to the first network location in response to a request from the first network location.

5. The method of claim 1, wherein presenting to the first network location the question comprises:
transmitting the question to an entity controlling the first network location for display to a user along with the content of the first network location.

6. The method of claim 1, further comprising:
identifying words or word clusters in the content of the first network location; and
selecting, from a question inventory of questions to be answered, the question to be presented to the first network location, wherein the question includes words or word clusters that match the words or word clusters in the content of the first network location.

7. The method of claim 6, wherein the question inventory comprises words or word clusters derived from the question and a map linking the question with the words or word clusters appearing in the question.

8. A system comprising one or more computers and one or more storage devices storing instructions that, when executed by the one or more computers, cause the one or more computers to perform operations comprising:
presenting to a first network location a question determined to be topically relevant to the first network location based on content of the first network location, wherein the first network location is a webpage in an online social network;
receiving an answer to the question from the first network location;
transmitting a response for display to a user at a second network location, wherein the response includes the answer to the question; and
receiving information relating to a rating for the answer from the user.

9. The system of claim 8, the operations further comprising:
storing the rating for use in identifying one or more network locations that are topically relevant to the question.

10. The system of claim 8, wherein the rating is submitted by a first user that is different from a second user that submitted the question and that is different from a third user that submitted the answer.

11. The system of claim 8, wherein the question is presented to the first network location in response to a request from the first network location.

12. The system of claim 8, wherein presenting to the first network location the question comprises:
transmitting the question to an entity controlling the first network location for display to a user along with the content of the first network location.

13. The system of claim 8, the operations further comprising:
identifying words or word clusters in the content of the first network location; and
selecting, from a question inventory of questions to be answered, the question to be presented to the first network location, wherein the question includes words or word clusters that match the words or word clusters in the content of the first network location.

14. The system of claim 13, wherein the question inventory comprises words or word clusters derived from the question and a map linking the question with the words or word clusters appearing in the question.

15. A computer readable medium encoded with a computer program, the program comprising instructions that when executed by one or more computers cause the one or more computers to perform operations comprising:
presenting to a first network location a question determined to be topically relevant to the first network location based on content of the first network location, wherein the first network location is a webpage in an online social network;
receiving an answer to the question from the first network location;
transmitting a response for display to a user at a second network location, wherein the response includes the answer to the question; and
receiving information relating to a rating for the answer from the user.

16. The computer readable medium of claim 15, the operations further comprising:
storing the rating for use in identifying one or more network locations that are topically relevant to the question.

17. The computer readable medium of claim 15, wherein the rating is submitted by a first user that is different from a second user that submitted the question and that is different from a third user that submitted the answer.

18. The computer readable medium of claim 15, wherein presenting to the first network location the question comprises:
transmitting the question to an entity controlling the first network location for display to a user along with the content of the first network location.

19. The computer readable medium of claim 15, the operations further comprising:
identifying words or word clusters in the content of the first network location; and
selecting, from a question inventory of questions to be answered, the question to be presented to the first network location, wherein the question includes words or word clusters that match the words or word clusters in the content of the first network location.

20. The computer readable medium of claim 19, wherein the question inventory comprises words or word clusters derived from the question and a map linking the question with the words or word clusters appearing in the question.
